(19) United States
(12) Patent Application Publication
(10) Pub. No.: US 2003/0152007 A1
(43) Pub. Date: Aug. 14, 2003

(54) Disk recording system by data reading and straightforward conversion to digital data

(75) Inventor: Akira Tsukihashi, Ohra-gun (JP)

Correspondence Address: HOGAN & HARTSON L.L.P., 500 S. GRAND AVENUE, SUITE 1900, LOS ANGELES, CA, 90071-2611, US

(73) Assignee: SANYO ELECTRIC CO., LTD.

(21) Appl. No.: 10/354,344

(22) Filed: Jan. 29, 2003

(30) Foreign Application Priority Data
Feb. 13, 2002 (JP) 2002-35982

(51) Int. Cl. G11B 7/00

(52) U.S. Cl. 369/59.23; 369/124.06

(57) ABSTRACT

EFM signals including margin bits read from a CD are passed to an EFM copy circuit. After cutting one bit from the margin bits, the EFM copy circuit stores the EFM signals with the margin bits into a buffer. The EFM copy circuit reads the EFM signals including the margin bits from the buffer, decompresses the margin bits, and supplies the EFM signals with the decompressed margin bits to a write strategy circuit. Then, the EFM signals are written onto a CDR from the recording start position on the CDR, which is detected by the information from a WBL detection circuit. The start address of the EFM data to be read from the buffer is located from subcode transferred from a subcode detaching circuit to the EFM copy circuit. In this manner, the content of a CD with copy guard protection can be copied to another disk.

### BACKGROUND OF THE INVENTION

1. Field of the Invention

The present invention relates to a disk recording system in which write signals are generated from signals read from a disk and then written onto another disk, and also relates to a disk recording device and a disk replay device for use with such systems.

2. Description of Related Art

Disk recording systems in which data is written onto optically readable disks, such as the CDR, CDRW, DVDR, and other systems, are well known. In particular, there is available an audio-use CDR whose purchase price includes a compensation payment to owners of copyrighted content. These CDRs are intended for use in making home-use copies of copyright protected audio and music content. Purchasers are allowed to record the content of a commercial audio/music CD for their private use only.

Meanwhile, many recently-released computer products have CDR drives provided with a function of directly backing up and writing the content of an audio CD to a CDR, and it is difficult to technically restrict the audio CD backup function of these computer systems. In response, an increasing number of audio, especially music, CD manufactures modify their CDs so that they cannot be readily copied with a personal computer, but so that they can still be played on commonly available CD players. This method of audio CD manufacture is known as recording with copy guards. That is, such a function is incorporated in the CD products that prevents computers from reading (ripping) the data on a disk and writing to another disk.

Audio CDs with the above-mentioned copy preventing function have a demerit in that legitimate private recording using audio-use CDRs is also usually prevented.

### SUMMARY OF THE INVENTION

The present invention advantageously enables legitimate backing up of audio CDs.

In the present invention, Eight-to-Fourteen Modulation (EFM) signals read from a disk containing content such as music or other audio signals may be written onto a CDR 40 in a manner that the EFM signals essentially remain intact. Thus, the EFM signals can be copied as is even if copy guard manipulation for EFM process was taken. Accordingly, the content of an audio CD with copy guard can be recorded onto an audio-use CDR for private use.

By compressing the digital data generated from the read signals and storing the data consisting of a reduced number of bits per signal into memory, a storage buffer can be employed effectively. Particularly, by compressing the data into 16 bits per signal, a general-purpose memory can be employed effectively.

The beginning of the data of the signals read from the disk is located from subcode and write signals corresponding to read signal data are recorded onto a recording disk medium sequentially from the start address of the stored data of the read signals. The write signals corresponding to sequential read signal data can be recorded onto a CDR from the data recording start position on the CDR.

### BRIEF DESCRIPTION OF THE DRAWINGS

FIG. 1 is a block diagram showing an overall configuration of a disk recording system of the present invention.

FIG. 2 is a flowchart illustrating a writing operation.

### DESCRIPTION OF THE PREFERRED EMBODIMENT

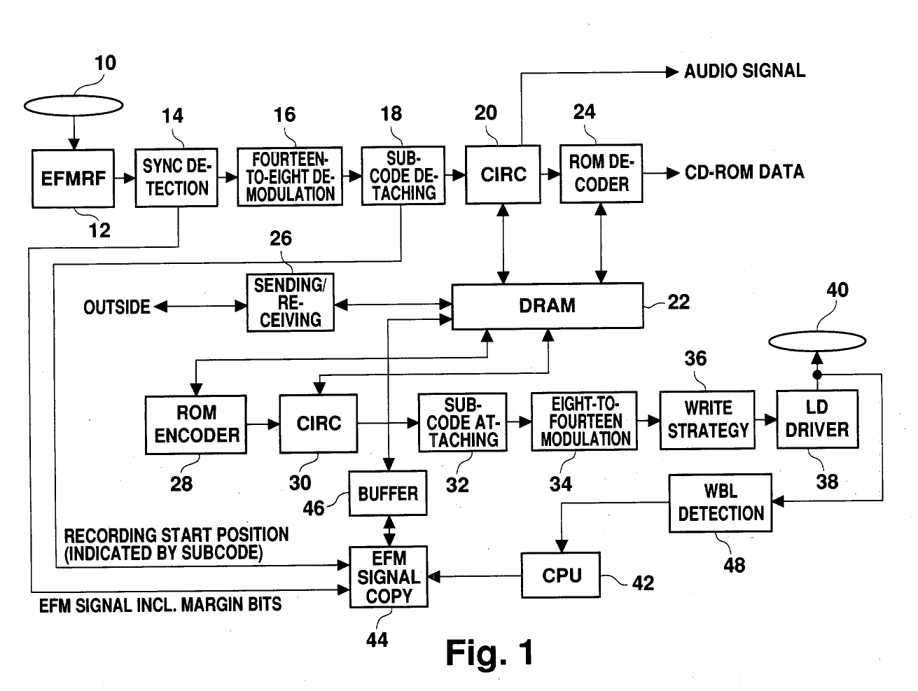

The present invention will now be described in detail with reference to a preferred embodiment illustrated in the accompanying drawings. FIG. 1 is a block diagram showing an overall configuration of a disk recording system according to a preferred embodiment of the invention. A pickup reads signals from a CD 10 on which music was recorded. Generally, a laser diode irradiates light on a CD and reflected light is converted into electric signals by a photo diode, and thereby radio frequency signals (EFM signals) are read out. The thus-read EFM signals are supplied to an EFMRF circuit 12 where the EFM signals are amplified and clocks synchronized with the EFM signals are generated. The thus-generated clocks are used in subsequent circuits as appropriate.

For the amplified EFM signals, synchronization per data signal is detected in a sync detection circuit 14. An EFM signal is a 14-bit data signal consisting of eight bits of source data and redundant bits. An actually recorded data signal also includes three margin bits added to the 14 bits. The sync detection circuit 14 detects source data boundaries and removes the margin bits.

Output of the sync detection circuit 14 is supplied to a fourteen-to-eight demodulation circuit 16 where 8-bit source data is reproduced from a 14-bit EFM signal. The source data retrieved in the fourteen-to-eight demodulation circuit 16 is supplied to a subcode detaching circuit 18 where subcode describing time data of audio data is detached from the source data. Output of the subcode detaching circuit 18, in the form of source data from which the subcode was detached, is supplied to a CIRC (Cross Interleave Reed-Solomon Code) circuit 20 where the data is error corrected, and from where the data is stored in a DRAM 22. If the disk 10 is a CDROM having data stored thereon, the output of the CIRC circuit 20 is supplied to a ROM decoder 24 where coded data is decoded and the decoded data is stored in the DRAM 22.

After the source data and decoded data are thus once stored in the DRAM 22, they are sent to a host computer through a sending/receiving circuit 26. That is, audio data and decoded data are supplied to the host computer to which the disk recording system is connected over a communications line. The audio data from the CIRC circuit 20 and the decoded data from the ROM decoder 24 can be output directly.

Meanwhile, data to be written supplied from the host computer over the communications line is received by the sending/receiving circuit 26 and stored in the DRAM 22. From the DRAM 22, CDROM data is encoded by a ROM encoder 28 and supplied to a CIRC circuit 30 and audio data is directly supplied to the CIRC circuit 30 where error correction code is added to the data. Output of the CIRC circuit 30 is supplied to a subcode attaching circuit 32 where a subcode is attached to the data. Output of the subcode attaching circuit 32 is supplied to an eight-to-fourteen modulation (EFM) circuit 34 where 8-bit data is converted to 14-bit data. The 14-bit data is converted into pulse signals by a write strategy circuit 36. Output of the write strategy circuit 36 is supplied via a laser diode drive circuit 38 to a laser diode. By laser irradiation of a CDR 40 with the laser diode, the data supplied from the host computer is written onto the CDR 40. This system has a CPU 42 and the above-described operations are performed under the control of the CPU 42.

Although, in the described example of operation of the disk recording system, the data read from the CD 10 is sent to the outside and the data received from the outside is written onto the CDR 40, the data retrieved from the CD 10 may be directly written onto the CDR 40.

The disk recording system of the present embodiment of the invention has a function of copying data in the EFM signal form. Specifically, the system includes two CD drives and carries out data copying such that audio data consisting of EFM signals read from an audio CD 10 is written onto a CDR 40. EFM copying will be explained below.

Because the CD 10 is an audio CD, when a command to make an EFM copy of its content is input to the system, the CPU 42 commands the sync detection circuit 14 to output EFM signals including margin bits. Although the sync detection circuit 14 normally outputs 14-bit data EFM signals generated by EFM of 8-bit source data, in the present embodiment, it outputs 17-bit data EFM signals including three margin bits added to the 14 bits, as read from the CD 10.

The 17-bit EFM signals including three margin bits from the sync detection circuit 14 are supplied to an EFM copy circuit 44. A buffer 46 is connected to the EFM copy circuit 44 and the EFM copy circuit 44 writes the EFM signals including the margin bits into the buffer 46. Ordinarily, the three margin bits may be one of four patterns. The EFM copy circuit 44 compresses the three margin bits into two bits without deteriorating the data and stores a total of 16 bits constituting an EFM signal in the buffer 46.

As general-purpose memories have bit widths of 8, 16, 32 bits, or the like, the system can effectively employ these memories effectively by compressing the data into 16 bits per signal.

Meanwhile, signals read from a CDR 40 are supplied to a wobble (WBL) detection circuit 48 where wobble signals recorded in pregrooves of the CDR 40 are detected and absolute time in pregroove (ATIP) is obtained. By ATIP, a data recording start position on the CDR 40 is detected. Information about the recording start position is supplied to the EFM copy circuit 44 via the CPU 42.

The EFM copy circuit 44 reads the EFM signals from the buffer 46 and begins reading at a start address of the EFM signal data stored in the buffer 46. The subcode is transferred from the subcode detaching circuit 18 to the EFM copy circuit and it includes information about the arrangement of the data obtained by the fourteen-to-eight demodulation. From the subcode, the EFM copy circuit 44 locates the start address of the EFM signal data including the margin bits stored in the buffer 46.

The EFM copy circuit 44 reads the EFM signals from the buffer 46 from the data start address, demodulates the two margin bits into three margin bits, and supplies the EFM signals including three margin bits to the write strategy circuit 36. From the write strategy circuit 36, the EFM signals including three margin bits are supplied to the LD driver 38 and written onto the CDR 40. Writing onto the CDR 40 begins at the data recording start position identified by the information from the WBL detection circuit 48, as mentioned above.

In this manner, the data existing in the buffer 46 is sequentially written onto the CDR 40. Immediately after the writing of the buffered data has finished, lead-in data is written onto the area between the record start position of the media and the data recording start position, and copying to the disk is complete at the termination of the lead-in write.

The writing of the EFM signals is performed at a fixed frequency and revolution of the CDR 40 should be controlled so that the wobble signals read from the CDR 40 coincide with a fixed frequency generated by a crystal oscillator. The rate of revolution of the CD 10 need not always coincide with the revolution speed of the CDR 40, as the presence of the buffer 46 eliminates adverse effects of differences in revolution speed.

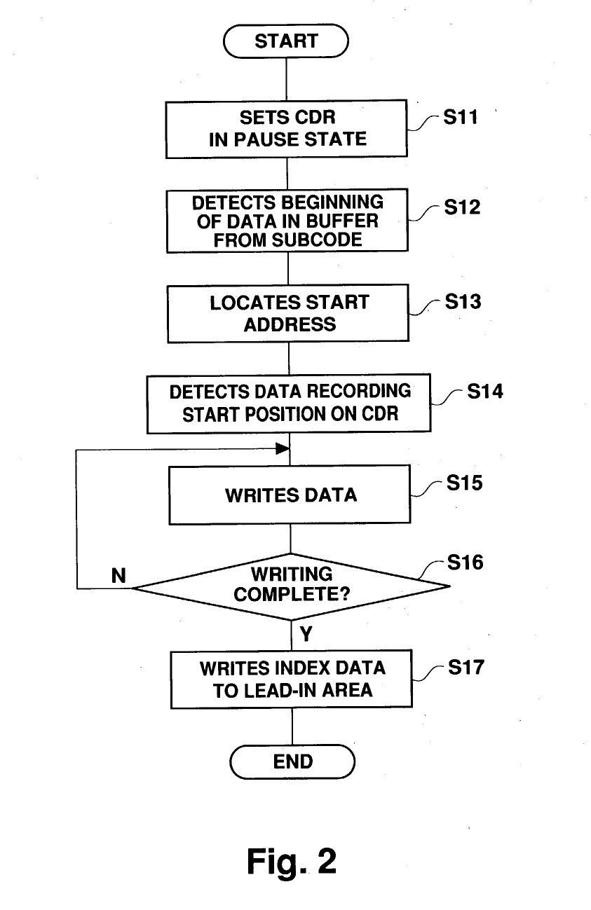

The operation flow of writing the EFM signals from the buffer 46 onto the CDR 40 is illustrated in FIG. 2. The drive for writing to CDR 40 sets the CDR in a pause state in which the CDR is ready to be written (S11). In this state, the EFM copy circuit 44 detects the beginning of the data existing in the buffer 46 from the subcode transferred from the subcode detaching circuit (S12). Then, the EFM copy circuit locates a block start address by subcode on the buffer 46 (S13). After detecting a data recording start position on the CDR 40 as determined by the information from the WBL detection circuit 48 (S14), the data is written from the buffer 46 to the CDR, starting at the data recording start position (S15). It is determined whether the writing of the data has finished (S16). Immediately after the writing has finished, data is recorded onto the lead-in area between the record start position of the medium and the data recording start position (S17). At the termination of writing of the lead-in, the writing of the EFM signals onto the CDR 40 finishes.

The data to be written in the lead-in area is table of contents (TOC) data, or, in other words, the index of the disk. The TOC stores a first track number, a last truck number, the start addresses of all tracks, and the start address of a lead-out track.

While the buffer 46 is separate from the DRAM 22 in the above-described example of the embodiment, a part of the DRAM 22 may be used as the buffer 46 for ordinary applications.

It is also preferable to send the EFM signals read from the CD 10 to the host computer. In such a situation, the EFM signals (16 bits per signal) including two margin bits, which have been stored in the buffer 46 in the manner described above, are passed across the DRAM 22 to the sending/receiving circuit 26 from which they are sent to the host computer.

However, if the EFM signals stored in the buffer 46 are sent directly, the start of the data cannot be identified. Thus, in the manner described above, the EFM copy circuit 44 reads the data from the buffer 46 from the start address of the data located, based on the subcode supplied from the subcode detaching circuit 18, and sends it to the host computer. It may be possible to integrate the buffer 46 into the DRAM 22 and supply the data directly from the buffer 46 to the sending/receiving circuit without being passed across the DRAM 22. Although in such a case it is also assumed that the buffer 46 is separate from the DRAM 22, a portion of the DRAM 22 may be used as the buffer 46 for ordinary application.

After receiving data sent in the manner described above, the host computer can send the data to another system or device, or back to the system from which it received the data. The 16-bit EFM signals sent from the host computer are received by the sending/receiving circuit 26, passed across the DRAM 22, and stored in the buffer 46. In this case also, it may be possible to integrate the buffer 46 into the DRAM 22 and supply the data directly from the sending/receiving circuit 26 to the buffer 46 without being passed across the DRAM 22.

In the same manner as described above, the EFM copy circuit 44 locates the data recording start position on the CDR 40, based on the information from the WBL detection circuit 48, reads the EFM signals from the buffer 46, and demodulates the two margin bits into three margin bits. Then, the EFM copy circuit supplies the thus obtained 17-bit EFM signals to the write strategy circuit 36. Thus, the same 17-bit EFM signals read from the CD 10 are recorded onto the CDR 40.

Immediately after the writing of the data has finished, lead-in data is written onto the area between the record start position of the media and the data recording start position, and the copy to the disk finishes at termination of the lead-in writing.

In the disk recording system of the present embodiment, as described above, EFM signals read from a CD 10 may be written onto a CDR 40 in a manner that the EFM signals remain essentially intact. That is, the signals are written onto the CDR 40 without undergoing fourteen-to-eight demodulation. Thus, the content of the CD can be copied as is, even if EFM copy guard protection was employed. Accordingly, the content of an audio CD can be recorded onto an audio-use CDR for private use. Because the read data is written straight forwardly without being error corrected, there is a high probability of copied data deteriorating. Thus, the quality of sound to be reproduced from another CDR to which a copy of original music content was copied through a plurality of copies would be deteriorated as in analog dubbing of music tape, and, consequently, there is a least possibility that the copy user be accused of infringement of copyright.

A CD drive that is capable of recording and replay and attached to a host device such as a personal computer is able to perform the EFM copy in this manner: the CD drive reads audio/music data consisting of EFM signals from a CD 10 and the data is once stored in a storage medium such as a hard disk of the host device, and then the CD drive records the data onto a CDR 40. More specifically, the EFM signals output from the sync detection circuit 14 are sent to the host device and the EFM signals from the host device are supplied to the EFM copy circuit 44.

What is claimed is:

1. A disk recording system which generates write signals from signals read from a disk having content and writes the write signals onto a recording disk medium, comprising:
a circuit for digitizing the signals read from said disk in a manner that the signals remain intact, thus converting the read signals into digital data including margin bits; and
a circuit for converting the digital data into write signals; and
a circuit for recording the write signals onto the recording disk medium.

2. A disk recording system according to claim 1, further comprising:
a circuit for compressing the digital data generated from said read signals:
a memory for storing the compressed digital data consisting of a reduced number of bits into a memory;
a circuit for decompressing the data retrieved from the memory; and
a circuit for converting the decompressed data into write signals.

3. A disk recording system according to claim 2, wherein
the digital data generated from said read signals consists of 17 bits, said compressing circuit compresses the 17-bit data into 16-bit data, and said memory stores the 16-bit data into the memory.

4. A disk recording system according to claim 1, wherein
said recording circuit locates the beginning of the stored data of said read signals from subcode obtained by demodulating the read signals and records the write signals corresponding to the data of the read signals sequentially from the located beginning of the data onto the recording disk medium.

5. A disk recording device for use in a disk recording system which generates write signals from signals read from a disk having content and writes the write signals onto a recording disk medium, comprising:
a circuit for digitizing the signals read from said disk in a manner that the signals remain intact, thus converting the read signals into digital data including margin bits; and
a circuit for converting the digital data into write signals; and
a circuit for recording the write signals onto the recording disk medium.

6. A disk recording device according to claim 5, further comprising:
a circuit for compressing the digital data generated from said read signals:
a memory for storing the compressed digital data consisting of a reduced number of bits into a memory;
a circuit for decompressing the data retrieved from the memory; and
a circuit for converting the decompressed data into write signals.

7. A disk recording device according to claim 6, wherein
the digital data generated from said read signals consists of 17 bits, said compressing circuit compresses the 17-bit data into 16-bit data, and said memory stores the 16-bit data into the memory.

8. A disk recording device according to claim 5, wherein
said recording circuit locates the beginning of the stored data of said read signals from subcode obtained by demodulating the read signals and records the write signals corresponding to the data of the read signals sequentially from the located beginning of the data onto the recording disk medium.

9. A disk replay device for use in a disk recording system which generates write signals from signals read from a disk having content and writes the write signals onto a recording disk medium, comprising:
a circuit for digitizing the signals read from said disk in a manner that the signals remain intact, thus converting the read signals into digital data including margin bits; and
a circuit for outputting the digital data including the margin bits.
